(19) United States
(12) Patent Application Publication
(10) Pub. No.: US 2026/0366680 A1
(43) Pub. Date: Nov. 19, 2026

(54) GAS SENSING PIPELINE MARKER

(71) Applicant: Southern California Gas Company, Los Angeles, CA (US)

(72) Inventors: Hector Serrano, Downey, CA (US); Krikor Tasmajian, Pasadena, CA (US)

(21) Appl. No.: 19/208,128

(22) Filed: May 14, 2025

(51) Int. Cl. F17D 5/00; G01V 15/00

(52) U.S. Cl. CPC F17D 5/005; G01V 15/00

(57) ABSTRACT

A pipeline marker with gas sensing capabilities includes a marker body that serves as both a regulatory-compliant pipeline marker and a housing for multiple gas sensors. The marker has a cavity within its body where gas sensors are mounted, and air flow channels direct environmental air to the sensors to detect the presence of various gases that would indicate pipeline leaks. The design allows pipeline operators to fulfill regulatory marking requirements while simultaneously monitoring for gas leaks. The marker can detect multiple gases including methane, hydrogen sulfide, and other hydrocarbons, and can monitor multiple pipelines simultaneously. The marker's form factor can vary from triangular to circular columns with a minimum internal diameter of 2 inches. The marker has a modular design for serviceability and is configured to function in various environmental conditions while maintaining an inconspicuous appearance.

### CROSS-REFERENCE TO PRIOR APPLICATIONS

Not applicable.

### BACKGROUND OF THE INVENTION

### Area of the Art

The present invention relates to a pipeline marker with gas sensing capabilities, and in particular, a pipeline marker which has integrated gas sensors in its body.

### DESCRIPTION OF THE BACKGROUND ART

Pipeline markers are federally required devices for any entity that operates a buried pipeline. They must be located at each public road crossing, railroad crossing, and in sufficient number along the remainder of each buried pipeline so that its location is accurately known. The Code of Federal Regulations that covers line markers is CFR 195.410.

An important aspect of pipeline safety is detecting leaks in pipelines, particularly those carrying gases such as methane, natural gas, sulfur-containing gases, or other hydrocarbons. Traditionally, leak detection and pipeline marking have been separate functions requiring separate installations and equipment.

Prior art in pipeline leak detection, such as described in U.S. Patent No. 9,869,602 Merlob, focuses on devices and methods for detecting leaks in pipes by inserting sensor assemblies into the pipeline itself. In Merlob, a sensor assembly is inserted into a pipe to detect vibrations caused by a leak, with a guiding device connected to the sensor assembly and a position locating device used to determine the location of the sensor assembly. This approach requires physical access to the pipeline interior and is reactive rather than continuously monitoring.

However, the present invention is fundamentally different from Merlob's approach in several key aspects. First, our invention is an above-ground standalone unit that detects gas leaks without requiring attachment to or insertion into the pipeline itself. This allows the device to be placed at varying distances from the pipeline and enables a single unit to monitor multiple pipelines simultaneously. Second, while Merlob's invention relies on hydrophones to detect sound waves or vibrations, our invention directly detects the presence of gases such as methane, sulfur-containing gases, and other hydrocarbons in the air.

Other methods of detecting pipeline leaks include using dyes in different plumbing lines, tracing pipelines with stethoscopes while listening for audible leak indicators, or visually inspecting for signs such as dripping liquid, cracks, dents, and the like. However, these methods are often imprecise, labor-intensive, and not suitable for continuous monitoring.

These existing methods share a common disadvantage: they are separate from the pipeline marking system that operators are already required to install and maintain. This separation results in additional costs, additional infrastructure, and missed opportunities for efficient pipeline monitoring.

Thus, it would be preferable to have a more efficient system that combines the federally required pipeline marking function with continuous gas leak detection capabilities. The present invention meets these and other needs.

### SUMMARY OF THE INVENTION

In the most general aspect of the present invention, a pipeline marker with gas sensing capabilities is disclosed. The pipeline marker has one or more gas sensors that are integrated into the body of the marker, allowing the unit to function both as a mandatory pipeline marker and as a gas sensing device.

In one aspect, the pipeline marker maintains its required regulatory function of identifying that a buried pipeline is in proximity to the marker, while simultaneously providing the capability to detect any gas release from nearby pipelines. This dual functionality allows pipeline operators to fulfill regulatory requirements for marking their pipelines while also continuously monitoring for potential gas leaks.

In another aspect, the design allows for gases to enter a cavity within the marker where the sensors are located so that gases can be effectively detected. The marker body is designed to direct air flow to the sensor cavity, so any mixture of gases in the air will be directed to the sensor cavity, allowing the gas sensors to detect them.

In another aspect, the pipeline marker has a modular design that facilitates servicing the gas detectors while maintaining an inconspicuous appearance that resembles a standard pipeline marker. This design deters theft and vandalism while providing easy maintenance access.

In another aspect, the pipeline marker is designed to operate effectively in various environmental conditions, properly housing the gas sensors to allow them to function in all weather conditions they may encounter in the field.

In another aspect, the pipeline marker includes multiple gas sensors capable of detecting different types of gases simultaneously. These may include sensors for methane, hydrogen sulfide, carbon monoxide, propane, butane, ethane, carbon dioxide, nitrogen oxides, volatile organic compounds (VOCs), and other hydrocarbons or potentially hazardous gases that might leak from pipelines. This multi-gas detection capability allows a single marker to monitor for various types of pipeline leaks regardless of the specific contents being transported.

In another aspect, the pipeline marker's form factor can be customized to meet specific environmental, aesthetic, or functional requirements while maintaining its primary functions as both a pipeline marker and gas detection system. The marker may be constructed in various shapes including triangular, square, pentagonal, hexagonal, octagonal, oval, or circular columns. These different geometric configurations allow for optimized placement depending on terrain, visibility requirements, and sensor positioning needs. The marker body may have a minimum internal diameter of 2 inches to accommodate the necessary sensing equipment, power systems, and electronic components.

The present invention accordingly provides for a pipeline marker with gas sensing capabilities including a marker body configured to be visible above ground to identify the location of one or more buried pipelines, and one or more gas sensors housed within a cavity in the marker body. The cavity is designed to allow airflow so that gases from any pipeline leak can enter the cavity and be detected by the sensors.

The present invention also provides a method for simultaneously marking and monitoring pipelines. In the method, a pipeline marker with integrated gas sensors is installed along pipeline routes in compliance with regulatory requirements, and the gas sensors continuously monitor for the presence of gases that would indicate a pipeline leak.

These and other features and advantages of the present invention will become more apparent from the following detailed description of the preferred embodiments in conjunction with the accompanying drawings, which illustrate, by way of example, the operation of the invention.

### DESCRIPTION OF THE FIGURES

FIG. 1 is a side view of a pipeline marker with integrated gas sensors according to an embodiment of the present invention.

FIG. 2 is a bottom view of the pipeline marker showing the sensor cavity and air flow channels according to an embodiment of the present invention.

FIG. 3 is a perspective view of the top portion of the pipeline marker showing the outer shell according to an embodiment of the present invention.

FIG. 4 is a perspective view of the bottom portion of the pipeline marker showing the inner sensor mounting structure according to an embodiment of the present invention.

FIG. 5 is a cross-sectional view of the pipeline marker showing the integration of the sensors within the marker body according to an embodiment of the present invention.

FIG. 6 is a side view of the gas sensor module that fits within the pipeline marker according to an embodiment of the present invention.

FIG. 7 is an exploded view of the pipeline marker showing the assembly of components including the marker body, sensor housing, and gas sensors according to an embodiment of the present invention.

### DETAILED DESCRIPTION OF THE INVENTION

As will be described hereinafter in greater detail, the various embodiments of the present invention relate to a pipeline marker with integrated gas sensing capabilities. For purposes of explanation, specific nomenclature is set forth to provide a thorough understanding of the present invention. Description of specific applications and methods are provided only as examples. Various modifications to the embodiments will be readily apparent to those skilled in the art, and the general principles defined herein may be applied to other embodiments and applications without departing from the spirit and scope of the invention. Thus, the present invention is not intended to be limited to the embodiments shown, but is to be accorded the widest scope consistent with the principles and steps disclosed herein.

The present invention is a multi-use unit that acts as both a pipeline marker and a gas sensor housing. Traditional pipeline markers serve a single purpose: to identify the location of buried pipelines above ground. The present invention enhances this basic function by incorporating gas sensing capabilities directly into the pipeline marker structure, thereby providing continuous monitoring of the pipeline for potential gas leaks.

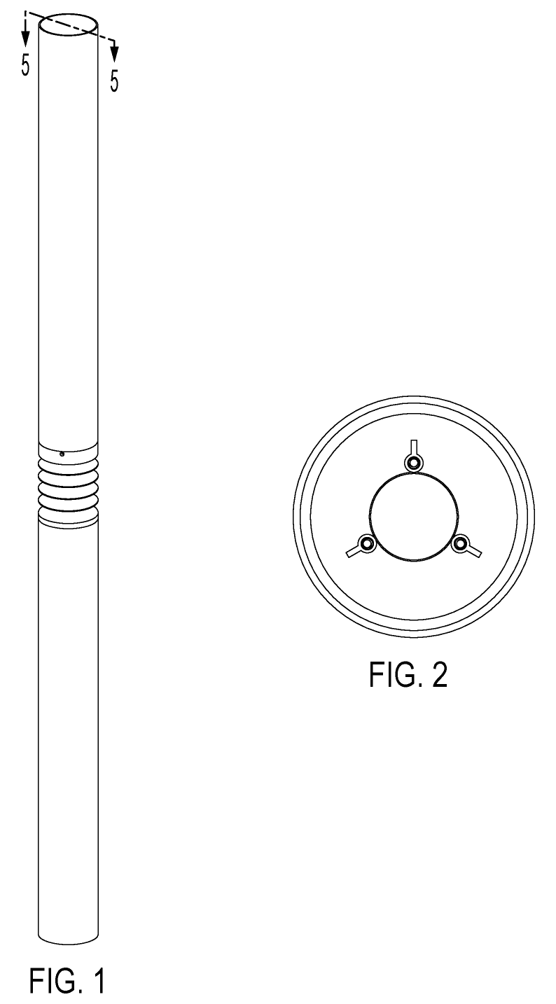

Referring to FIG. 1, an exemplary pipeline marker with gas sensing capabilities according to one embodiment is shown. The pipeline marker includes an elongated body that is designed to look like a standard pipeline marker, maintaining the visual appearance required by regulatory standards. The marker body has an upper portion that houses the gas sensing components. This upper portion is designed to be visually indistinguishable from a standard pipeline marker from the exterior, maintaining the inconspicuous nature of the device.

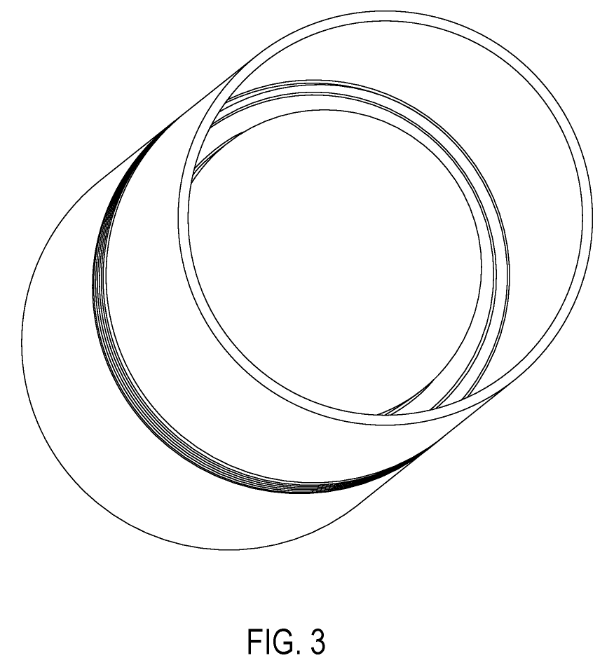

Referring to FIG. 2, a bottom view of the upper portion of the pipeline marker shows the sensor cavity and air flow channels. Bottom portion. Three through holes are for hardware assembly (nuts/bolts) that structurally hold the louvered sensor mounting assembly together. This design enhances the sensors' ability to detect even small amounts of gases in the surrounding air.

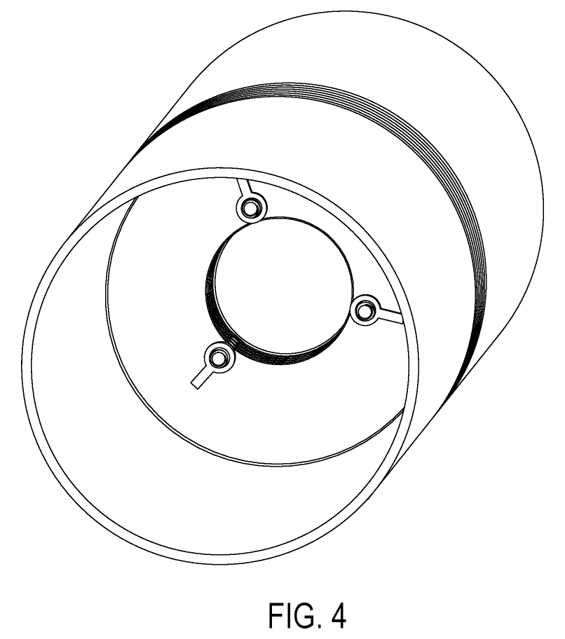

Referring to FIGS. 3 and 4, perspective views of the top and bottom portion of the pipeline marker show the outer shell and inner sensor mounting structure, respectively. The outer shell is designed to protect the sensors from environmental conditions while still allowing adequate airflow for gas detection. The inner structure provides mounting points for the gas sensors.

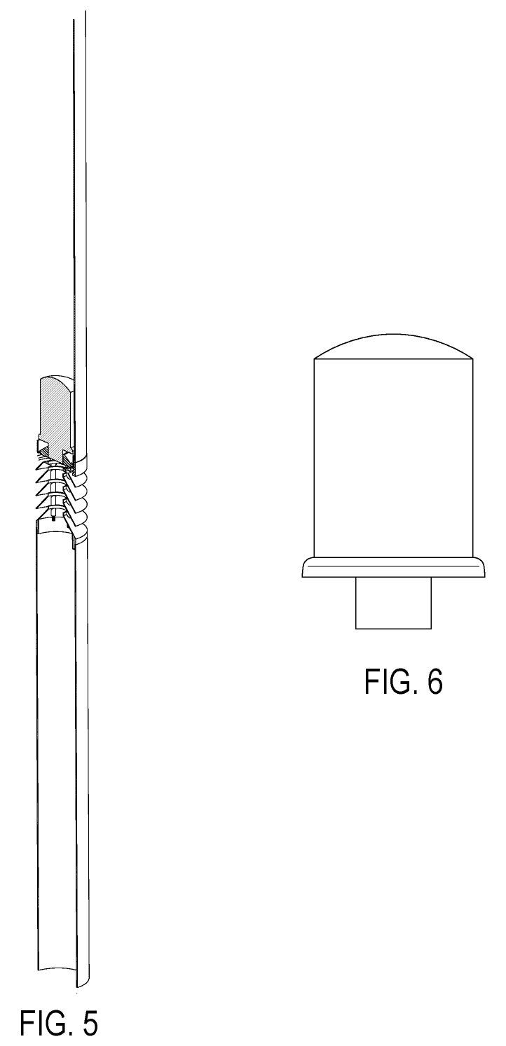

Referring to FIG. 5, a cross-sectional view of the pipeline marker shows how the sensors are integrated within the marker body. The design allows for the sensors to be installed in a protected cavity within the marker while still having access to the surrounding air. The marker body can include air inlets at strategic locations to enhance gas detection capabilities.

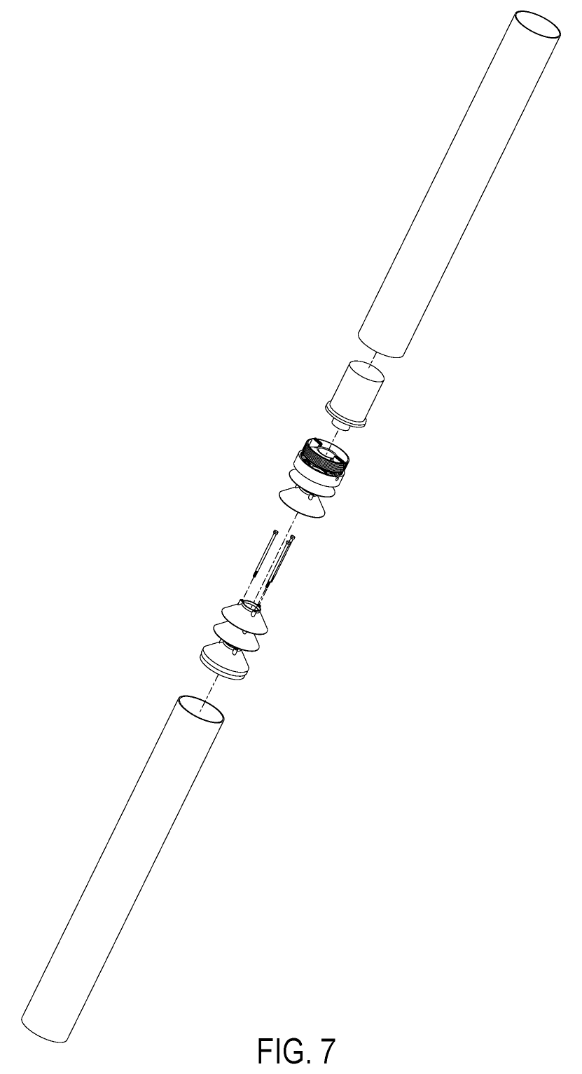

Referring to FIG. 6, a side view of the gas sensor module that fits within the pipeline marker is shown. The sensor module is designed to be replaceable and serviceable in the field, allowing for maintenance without replacing the entire pipeline marker. This modular approach reduces long-term maintenance costs and improves the system's reliability.

Referring to FIG. 7, an exploded view of the pipeline marker shows the assembly of components including the marker body, sensor housing, and gas sensors. The components are designed to fit together securely while still allowing for disassembly when maintenance is required. The gas sensors connect to the main body through a secure mounting system that protects the sensors from environmental damage while still allowing them to function effectively.

The various embodiments shown in the figures demonstrate that the gas sensing pipeline marker can be configured with multiple types of gas sensors to detect a wide range of gaseous compounds. These sensors may include, but are not limited to, semiconductor sensors, catalytic bead sensors, electrochemical sensors, infrared sensors, photoionization detectors, and optical sensors. The specific combination of sensors installed in a particular marker would depend on the types of pipelines being monitored and the gases they transport.

For methane and other hydrocarbon detection, the marker may utilize metal oxide semiconductor sensors or infrared absorption technology. For hydrogen sulfide and other sulfur-containing compounds, electrochemical sensors might be employed. Carbon monoxide detection could be accomplished through either electrochemical or optical sensors. The modular design of the marker allows for different sensor configurations to be installed based on specific monitoring requirements.

The physical form of the marker can vary significantly while maintaining its dual functionality. As shown across various figures, the marker body can be constructed in different geometric shapes. A triangular column design may offer advantages in terms of structural stability and directional indication. Square or rectangular columns provide flat surfaces that can accommodate larger regulatory markings and informational text. Hexagonal and octagonal designs offer multiple faces that can be used to direct sensors toward different pipelines or different directions for optimal gas detection coverage. Circular or oval columns may provide better aerodynamic performance in high-wind environments while maintaining a clean aesthetic appearance.

Regardless of the external geometry, the internal cavity is designed to house the necessary sensor components while providing optimal airflow patterns to ensure gases reach the detection elements. The various designs all maintain a minimum internal diameter of 2 inches to accommodate the necessary components while allowing for adequate air circulation around the sensors.

The present invention is designed to address several key challenges in pipeline monitoring. First, it combines two previously separate functions -- pipeline marking and leak detection -- into a single unit, reducing installation costs and minimizing visual impact. Second, it provides continuous monitoring rather than the periodic inspections that characterize traditional leak detection methods. Third, it is designed to be inconspicuous, reducing the risk of theft or vandalism that might target more obvious monitoring equipment.

In operation, the pipeline marker with gas sensing is installed at required locations along a pipeline route, typically at road crossings, railroad crossings, and at regular intervals along the pipeline as required by regulations. Once installed, the marker serves its primary function of identifying the pipeline location while the integrated gas sensors continuously monitor the surrounding air for the presence of various gases.

If gases are detected, the sensors can trigger various types of alerts depending on the specific implementation. These might include wireless notifications to a central monitoring system, visual indicators on the marker itself, or other alerting mechanisms. The specific alert methods would be selected based on the operating environment and the pipeline operator's preferences.

The modular design of the invention allows for the gas sensing components to be replaced or upgraded without replacing the entire marker. This is particularly important for maintaining the system over time, as sensor technology improves or as sensors reach the end of their operational life.

The invention also provides environmental benefits by enabling earlier detection of gas leaks, which can help reduce the release of greenhouse gases and hazardous substances into the atmosphere. This early detection capability can also enhance safety by identifying potential hazards before they become serious safety risks.

The following claims are thus to be understood to include what is specifically illustrated and described above, what is conceptually equivalent, what can be obviously substituted and also what incorporates the essential idea of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

What is claimed is:

1. A gas sensing pipeline marker, comprising: a marker body configured to be installed above ground to visibly mark the location of one or more buried pipelines, the marker body complying with regulatory requirements for pipeline marking; a cavity formed within the marker body; a plurality of gas sensors housed within the cavity, wherein the plurality of gas sensors are configured to detect different gases in air; and one or more air flow channels configured to direct air from the surrounding environment to the cavity where the plurality of gas sensors are housed.

2. The gas sensing pipeline marker of claim 1, wherein the plurality of gas sensors are configured to detect at least two gases selected from the group consisting of: methane, hydrogen sulfide, carbon monoxide, carbon dioxide, propane, butane, ethane, nitrogen oxides, sulfur-containing gases, volatile organic compounds, and hydrocarbons.

3. The gas sensing pipeline marker of claim 1, wherein the marker body has a cross-sectional shape selected from the group consisting of: triangular, square, rectangular, pentagonal, hexagonal, octagonal, oval, and circular.

4. The gas sensing pipeline marker of claim 1, wherein the marker body has a minimum internal diameter of 2 inches to accommodate the plurality of gas sensors and associated electronic components.

5. The gas sensing pipeline marker of claim 1, wherein the marker body is configured to be positioned at varying distances from the one or more buried pipelines to provide optimal gas detection coverage.

6. The gas sensing pipeline marker of claim 1, wherein the plurality of gas sensors include at least two sensor types selected from the group consisting of: semiconductor sensors, catalytic bead sensors, electrochemical sensors, infrared sensors, photoionization detectors, and optical sensors.

7. The gas sensing pipeline marker of claim 1, wherein the plurality of gas sensors are configured to simultaneously monitor multiple pipelines carrying different substances.

8. The gas sensing pipeline marker of claim 1, further comprising a communication module configured to transmit specific gas identification information when a gas is detected above a predetermined threshold.

9. The gas sensing pipeline marker of claim 1, wherein the plurality of gas sensors are individually modularly designed to be independently replaceable without replacing other sensors or the entire marker body.

10. The gas sensing pipeline marker of claim 1, further comprising a power source to provide energy for the plurality of gas sensors and wherein the marker body's geometric shape is designed to optimize placement of the power source.

11. A method of simultaneously marking and monitoring pipelines, comprising: installing a pipeline marker with multiple integrated gas sensors above ground along one or more pipeline routes in compliance with regulatory requirements, wherein the pipeline marker has a geometric shape selected from the group consisting of triangular, square, rectangular, pentagonal, hexagonal, octagonal, oval, and circular; continuously monitoring for the presence of multiple different gases that would indicate a pipeline leak using the integrated gas sensors; detecting a specific gas leak from at least one of the one or more pipeline routes; and generating an alert that identifies the specific detected gas in response to detecting the gas leak.

12. The method of claim 11, wherein continuously monitoring comprises detecting at least three different gases selected from the group consisting of: methane, hydrogen sulfide, carbon monoxide, carbon dioxide, propane, butane, ethane, nitrogen oxides, sulfur-containing gases, volatile organic compounds, and hydrocarbons.

13. The method of claim 11, wherein continuously monitoring comprises simultaneously monitoring multiple pipelines carrying different substances with a single pipeline marker.

14. The method of claim 11, further comprising selecting the geometric shape of the pipeline marker based on terrain characteristics, visibility requirements, and optimal sensor positioning for the specific installation location.

15. The method of claim 11, further comprising transmitting the alert with specific gas identification information to a remote monitoring system.

16. A system for pipeline monitoring, comprising: a plurality of gas sensing pipeline markers installed above ground along one or more pipeline routes, each gas sensing pipeline marker comprising: a marker body complying with regulatory requirements for pipeline marking and having a geometric shape selected from the group consisting of triangular, square, rectangular, pentagonal, hexagonal, octagonal, oval, and circular; a cavity formed within the marker body; a plurality of different types of gas sensors housed within the cavity and each configured to detect different gases in air; and one or more air flow channels directing air to the plurality of different types of gas sensors; and a central monitoring station configured to receive gas identification data from the plurality of gas sensing pipeline markers.

17. The system of claim 16, wherein at least one of the gas sensing pipeline markers is positioned to simultaneously monitor multiple pipelines carrying different substances.

18. The system of claim 16, wherein the plurality of different types of gas sensors in each pipeline marker include at least three different sensor types, each configured to detect a different gas selected from the group consisting of: methane, hydrogen sulfide, carbon monoxide, carbon dioxide, propane, butane, ethane, nitrogen oxides, sulfur-containing gases, volatile organic compounds, and hydrocarbons.

19. The system of claim 16, wherein the geometric shape of each gas sensing pipeline marker is selected based on local environmental conditions, visibility requirements, and optimal sensor positioning for its specific installation location.

20. The system of claim 16, wherein the central monitoring station is configured to identify both a location of a gas leak and the specific type of gas detected based on data received from multiple gas sensing pipeline markers.
